(19) United States
(12) Patent Application Publication
(10) Pub. No.: US 2025/0326259 A1
(43) Pub. Date: Oct. 23, 2025

(54) Anti-Rattle Device and Bolt

(71) Applicant: Wheel Pros, LLC, Greenwood Village, CO (US)

(72) Inventors: Ryan Kennelly, Ogden, UT (US); Nigel Gayette, Ogden, UT (US); Ted Moncure, Long Beach, CA (US)

(73) Assignee: Wheel Pros, LLC, Greenwood Village, CO (US)

(21) Appl. No.: 18/643,591

(22) Filed: Apr. 23, 2024

(51) Int. Cl. B60D 1/24; B60R 9/10

(52) U.S. Cl. CPC B60D 1/249; B60R 9/10

(57) ABSTRACT

An anti-rattle device has a receiver tube with one or more receiver tube prong holes and two receiver tube hitch pin holes that line up with the hitch pin holes on a vehicle hitch receiver, through which a threaded pin is inserted. Inside the receiver tube, a top plate with prongs and a bottom plate are inserted. The wedge has a threaded hole and is then inserted and attached through a protrusion to a bottom plate with a slot and bottom plate pilot. As the pin is turned, the pin threaded section pulls the wedge, gradually pushing up the top plate, where the prongs slide through the receiver tube prong holes and engage the inner surface of the vehicle hitch receiver, which forces the bottom plate pilot into a bottom plate securing hole on the receiver tube, effectively securing the receiver tube to the vehicle hitch receiver on three sides.

### FIELD OF THE INVENTION

The present disclosure relates generally to the field of items used to connect bike/motorcycle racks and other devices to hitch receivers in vehicles, and more specifically to an anti-rattle device that uses an adjustable wedge to secure a tube into a vehicle receiver in a manner that eliminates the rattle and play in the connection.

### BRIEF SUMMARY OF THE INVENTION

An anti-rattle device has a receiver tube with one or more receiver tube prong holes and two receiver tube hitch pin holes that line up with the hitch pin holes on a vehicle hitch receiver. Once the receiver tube is inserted into the vehicle hitch receiver, a threaded pin is inserted to engage with three components of the invention that have been placed inside the receiver tube. Inside the receiver tube, a wedge with a threaded hole is placed between a top plate with prongs, and a bottom plate with the bottom place pilot. As the pin is turned, the pin threaded section pulls the wedge toward the side of the receiver tube, gradually pushing up the top plate, where the prongs slide through the receiver tube prong holes and engage the inner surface of the vehicle hitch receiver, which forces the bottom plate pilot into a bottom plate securing hole on the receiver tube, effectively securing the receiver tube to the vehicle hitch receiver on three sides. A cotter pin is inserted into a pin hole at the end of the pin to prevent the pin from backing out.

### BACKGROUND

Attaching a platform or wheeled vehicle to the back of a towing object goes back to around 4,000 BC when the first historical evidence exists showing carts that were towed by animals. Motorized vehicles have been used to tow trailers for over 100 years, with almost all car companies offering a “trailer hitch package” during the 1960′s. While the first trailer hitches were permanent and attached to the vehicle, over the years vehicle manufactures began to offer a hitch receiver or receiver tube, into which a receiver tube could be inserted and secured.

This smaller tube, or “receiver tube” could be attached to a trailer ball for towing a trailer. The receiver tube could also be manufactured as part of a larger device that a user would like to easily and quickly attach to and remove from the vehicle. For example, there are a multitude of bicycle/motorcycle racks, folding ramps and cargo carriers which can be quickly inserted into the receiver tube and temporarily attached by sliding a hitch pin through mating holes on the receiver tube and vehicle receiver, secured at one end by a bolt head and at the other end by a cotter pin.

A major problem with the current state of the art is that the receiver tube, by definition, has to be able to slide in and out of the receiver tube. As both parts are metal, and subject to considerable water and dirt/grit exposure, the receiver tube has to have adequate clearance between its outer surface and the inner surface of the receiver tube such that it does not get stuck in the vehicle hitch receiver.

This gap, even if a small gap, between the outer surface of the receiver tube and the inner surface of the vehicle hitch receiver tube leads to some “play” in the movement allowed the attached item. This creates several problems. First, the more “play”, the greater the attached item will rotate from side to side. On a rack storing a heavy item such as a motorcycle, this rotation can quickly damage the receiver tube and eventually lead to the receiver tube twisting and contorting, or even snapping off, leading to catastrophic possibilities for drivers following the vehicle. A second problem is that the play creates a rattling sound, which is both annoying and distracting, as the driver's attention is drawn, from time to time, to whether the attached rack or cargo carrier is going to break off of the car.

Problem Stated: Thus, it is desirable that the receiver tube be secured in the vehicle receiver hitch such that any “play” and rattling is minimized.

Prior Art. There are a number of patents and published patent applications that attempt to solve the problem, but none which provide the quality solution provided by this invention.

For example, U.S. Pat. No. 7,467,804 to Ezra describes a device for eliminating radial tilting in a receiver-type hitch due to rotational moment on the shank includes a collar, and three adjustment bolts. The collar has a center bar and a pair of side walls forming a U-shaped bracket that can fit over a reinforcing lip of the hitch receiver tube. A front wall on the collar has an opening for receiving a mount shank as it enters the receiver tube. The three adjustment bolts extend through the center bar to tighten the collar onto the hitch receiver tube. When the center adjustment bolt is tightened, the collar is secured onto the hitch receiver tube. When the adjustment bolts are tightened, the center bar of the collar moves downward away from the receiver tube, causing the opening in the front wall to pull down the shank against the inner wall of the tube and prevent radial tilting within the tube. Therefore, the anti-radial tilt device prevents radial tilting on receiver-type hitch components due to rotational moment created by unbalanced load on a hitch carrier.

This invention, however, is external to the hitch assembly and relies upon tightening screws to press the small tube against the receiver tube in a single direction. Another problem with this attempted solution is that it relies on small bolts to provide the necessary tension. These bolts and the threaded portions are directly exposed to water, dirt and grit kicked up by the rear wheels of the vehicle, leading to difficulty attaching and detaching the device when a user wishes to remove the hitch.

Another prior art is U.S. Pat. No. 9,616,720 to Horizon Global Americas. This patent covers A channel mount coupler is shown and described. The channel mount may include a body, a socket extending from the body and configured to accept a hitch ball, and a channel mount extending from the body. The channel mount may include a first flange, the first flange including at least one aperture and at least one recess generally circumscribing the aperture, the recess being generally acircular, and a second flange spaced from the first flange. The channel mount may also include an engagement member engaged with the recess, and a fastener engageable with the engagement member and the at least one aperture, where engagement of the engagement member and recess prevents rotation of the engagement member during engagement of the fastener with the engagement member, whereby the first and second flanges are engageable with a towed vehicle.

This invention, however, is extremely cumbersome and requires relatively complex (and time consuming) installation. It also relies on springs to decrease the rattle, whereas the current invention uses a wedge, which is a considerably stronger means.

US Publication No. 2023/0284442 to Wall teaches a device for lifting objects. The device comprises a pair of arms, a horizontal bar, a slide bar, and a housing. The pair of arms are configured to be in an open state to lift an object and in a closed state when the pair of arms are not being used. The device is configured to be elongated to a length for providing ease of loading and unloading of an object. The device further comprises a locking mechanism for providing stability during transit. The housing comprises a roller over a screw for providing easy displacement of the slide bar with respect to the housing.

This device, however, does not use a wedge, nor would it be suitable for a hitch receiver.

U.S. Pat. No. 8,419,041 to Kimpex, Inc. covers a hitch, which can be rigidly yet removably attached to a vehicle-mounted sleeve, comprises a longitudinally extending member which is configured to slide into the sleeve, and which locks therewith with a transverse locking device in a conventional manner. The member is divided into two sections along a plane which is inclined with respect to the longitudinal axis of the member. The sections are connected together by a bolt threading into one section while being operable from the outside of the other section. Due to the inclined plane separating both sections, tightening of the bolt causes the sections to slide in opposite directions within the sleeve until they abut and press on opposite inner walls of the sleeve, thereby eliminating play between the member and sleeve. The hitch is conceived such to prevent a user to drive without the locking device in place.

This invention, however, does not force the receiver tube against the inner sides of the receiver tube, but rather, provides another means of attaching a hitch to the hitch receiver.

U.S. Pat. No. 8,262,121 to Frog Marketing provides a rigid trailer hitch is disclosed that uses pressure produced by a wedge into force against trailer hitch receiver walls, while still retaining a retaining pin as a backup. The wedge can be driven by rotary force translated through a compound miter or a split wedge across a retaining pin.

This invention, however, does not use the wedge to force the receiver tube against the receiver tube, but rather slides the receiver tube into a wedge-shaped plug that has to be tightened through a long bolt that extends through the entire hitch receiver tube and receiver tube.

### SUMMARY OF THE INVENTION

This summary is provided to introduce concepts related to anti-rattle devices for hitch receivers in vehicles. The concepts are further described below in the detailed description. This summary is not intended to identify key features or essential features of the claimed subject matter, nor is it intended to be used to limit the scope of the claimed subject matter.

The present disclosure relates to an anti-rattle hitch receiver device. Inside the receiver tube, a wedge with a threaded hole is sandwiched between a top plate with one or more prongs and a bottom plate with a bottom plate pilot. The receiver tube has one or more receiver tube prong holes, through which the prongs on the top plate fit, and two receiver tube hitch pin holes that line up with the hitch pin holes on a vehicle hitch receiver. Once the receiver tube is inserted into the vehicle hitch receiver, a threaded pin is inserted to engage with three components of the invention that have been placed inside the receiver tube. Inside the receiver tube, a wedge with a threaded hole is placed between a top plate with prongs, and a bottom plate with the bottom place pilot. As the pin is turned, the pin threaded section pulls the wedge toward the side of the receiver tube, gradually pushing up the top plate, where the prongs slide through the receiver tube prong holes and engage the inner surface of the vehicle hitch receiver, which forces the bottom plate pilot into a bottom plate securing hole on the receiver tube, effectively securing the receiver tube to the vehicle hitch receiver on three sides. A cotter pin is inserted into a pin hole at the end of the pin to prevent the pin from backing out.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The anti-rattle device may, however, be embodied in many different forms and should not be construed as being limited to the embodiments set forth herein; rather, these embodiments are provided by way of illustration only and so that this disclosure will be thorough, complete and fully convey understanding to those skilled in the art.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and methods that are consistent with the subject matter as claimed herein, wherein:

FIG. 1 is a perspective view of one embodiment of the invention.

FIG. 2 is a perspective view of a second embodiment of the invention.

FIG. 3 is a perspective view of a third embodiment of the invention.

FIG. 4 is a front view of one embodiment of the invention.

FIG. 5 is a back view.

FIG. 6 is a right-side view.

FIG. 7 is a left side view.

FIG. 8 is a top view.

FIG. 9 is a bottom view.

FIG. 10 is an exploded, perspective view of one embodiment of the invention showing the various parts of the invention prior to assembly.

FIG. 11 is an exploded, perspective view of a second embodiment of the invention showing the various parts of the invention prior to assembly.

FIG. 12 is an exploded view of the bottom plate, top plate and wedge.

FIG. 13 is a front view, showing the invention before the wedge has been move toward the pin head.

FIG. 14 is a front view, showing the invention after the wedge has been screwed toward the pin head, forcing the top plate in an upwards direction, and the bottom plate in a downward direction.

FIG. 15 is a cross sectional view showing how the various parts of the invention work together to secure a receiver tube in a vehicle hitch receiver.

FIG. 16 is a front view of a second embodiment of the invention where the bottom plate has been removed and the wedge has a different shape that is found in the first embodiment.

FIG. 17 is a cross-sectional view of the embodiment illustrated in FIG. 14.

FIG. 18 is a cross-sectional view of the embodiment illustrated in FIG. 16.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The detailed description of various exemplary embodiments of the disclosure is described herein with reference to the accompanying drawings. It should be noted that the embodiments are described herein in such details as to clearly communicate the disclosure. However, the number of details provided herein is not intended to limit the anticipated variations of embodiments; on the contrary, the intention is to cover all modifications, equivalents, and alternatives falling within the spirit and scope of the present disclosure as defined by the appended claims.

It is also to be understood that various arrangements may be devised that, although not explicitly described or shown herein, embody the principles of the present disclosure. Moreover, all statements herein reciting principles, aspects, and embodiments of the present disclosure, as well as specific examples, are intended to encompass equivalents thereof.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may, in fact, be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It would be desirable to have a device that prevents rattling between a receiver tube and a vehicle hitch receiver.

To this, the present disclosure advantageously fills the abovementioned needs and addresses the aforementioned deficiencies by providing a wedge with associated components that creates pressure on three sides of a receiver tube, securing it inside a vehicle hitch receiver such that it does not rattle.

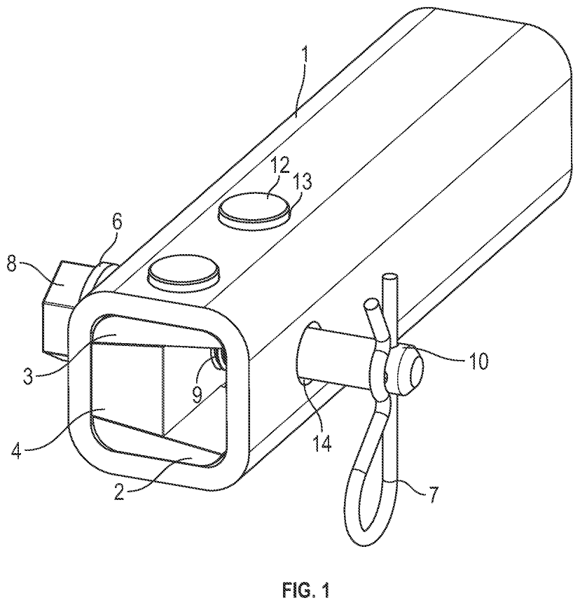

FIG. 1 is a perspective view of the invention in one embodiment. A receiver tube 1 can be slid into the hitch receiver of a vehicle. Attached to the receiver tube can be a trailer hitch, a bicycle or motorcycle rack, a cargo tray, a spare tire retainer or another device that can be removably connected to a vehicle hitch receiver. On the sides of the receiver tube 1 are two receiver tube hitch pin holes 14, and on the top of the receiver tube are one or more receiver tube prong holes 13. It is contemplated that the number of receiver tube prong holes will be at least one, up to a large number of holes depending on the configuration of each embodiment.

A pin 5, has a washer 6, and slides through the two receiver tube hitch pin holes and is secured on the other side of the receiver tube by a cotter pin 7. The pin 5 has a pin head 8, a pin threaded section 9, and at the far end, away from the pin head 8, one or more pin holes 10.

Inside the receiver tube 1, a wedge 4 is sandwiched between a top plate 3 and a bottom plate 2. The bottom plate 2 has a slot on its upper surface (not visible in this figure), which mates with a protrusion on the bottom of the wedge (also not visible in this figure). The bottom plate and wedge are sandwiched together and inserted first, then the top plate is inserted and held in place by one or more fingers as the prongs 12 on the top plate 3 are pushed through the receiver tube prong holes 13 on the receiver tube. The wedge 4 has a threaded wedge hole 11. The bottom plate 2 is gently wedge-shaped, with a wider end and a slightly rounded lower surface which enhances its ability to be gradually pulled toward the pin head 8 as the pin threaded section 8 is screwed into the threaded wedge hole. The top plate 3 is also gently wedge-shaped, with a slightly rounded upper surface which enhances its ability to be gradually pulled toward the pin head 8 as the pin threaded section 8 is screwed into the threaded wedge hole. The top plate 3 also has one or more prongs 12 on its upper surface, which mate with the one or more receiver tube prong holes 13 on the receiver tube 1.

This embodiment of the invention functions as follows. In this embodiment, there are two prongs, which mate with two receiver tube holes. The wedge, top plate and bottom plate are organized in a sandwich fashion, with the wedge in between the top plate and bottom plate. The bottom plate 2 has a slot on its upper surface, which mates with a protrusion on the bottom of the wedge. The bottom plate and top plate are inserted first and held in place by one or more fingers, then the wedge is inserted as the prongs 12 on the top plate 3 are pushed though the receiver tube prong holes 13 on the receiver tube. This secures the entire unit inside the receiver tube so that the receiver tube can be inserted into a vehicle hitch receiver.

The small end of the wedge is aimed toward the receiver tube hitch pin hole through which the pin will be inserted. The receiver tube is inserted into a hitch receiver, with the wedge hole lined up with the two receiver tube hitch pin holes. The pin is then inserted through the first receiver tube hitch pin hole and the pin threaded section engages mating threads in the wedge hole. As the pin is rotated, the pin threaded section “pulls” the wedge toward the inner side of the hitch receiver, on the same side of the hitch receiver where the hitch receiver's outer side is the side upon which rests the pin head and washer, with easy rotation made possible by the washer. As the wedge is pulled toward the side of the receiver tube, the larger end of the wedge gradually pushes the bottom plate down and the top plate up. As the top plate is pushed up, the prongs extend beyond the receiver tube prong holes and begin to engage with the inner surface of the upper part of the hitch receiver. This pushes the bottom plate harder and harder against the inner surface of the receiver tube. Eventually, the prongs will force the bottom of the receiver tube against the hitch receiver, creating two securing points: the prongs against the top of the hitch receiver and the bottom plate pushing the bottom of the receiver tube against the inner surface of the bottom of the hitch receiver. A third securing point is created as the pin threaded portion can no longer rotate, which causes the wedge and the pin head to secure the side of the receiver tube to the inner surface of the hitch receiver.

In one particular embodiment, the prongs are elliptical in shape, as are the receiver tube holes, but any shape can be used so long as the prong can extend through its corresponding receiver tube prong hole. As such, circular, rectangular and other shapes of prongs (and corresponding receiver tube prong hole shapes) are contemplated and any number of prongs from one to multiple prongs are contemplated.

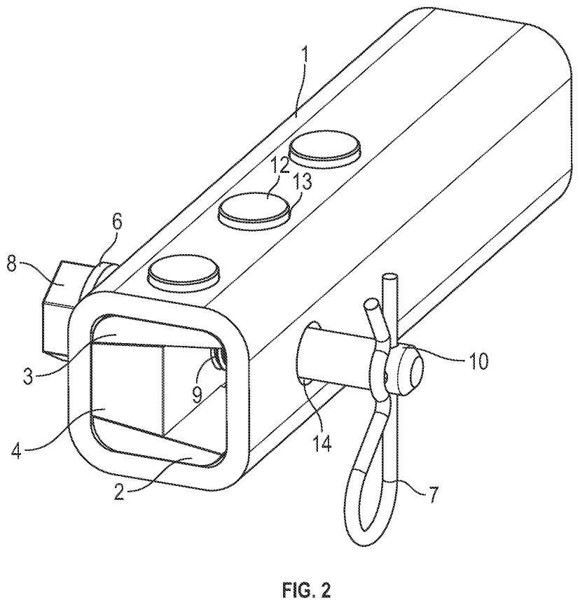

FIG. 2 is a perspective view of a second embodiment of the invention. The individual parts are very similar to the embodiment illustrated in FIG. 1, except in this embodiment there are three prongs 12, which extend through three receiver tube prong holes 13 in the receiver tube 1.

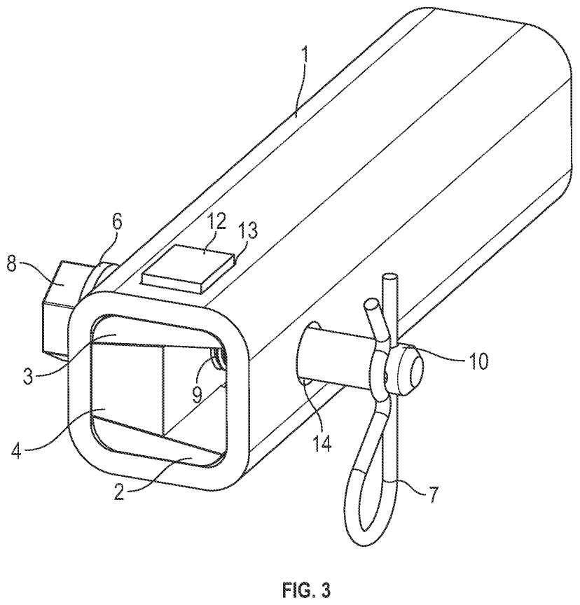

FIG. 3 is a perspective view of a third embodiment of the invention. The individual parts are very similar to the embodiment illustrated in FIG. 1, except in this embodiment there is only one prong 12, and it is square in shape, where the prong extends through a single, square-shaped receiver tube prong hole 13 in the receiver tube 1.

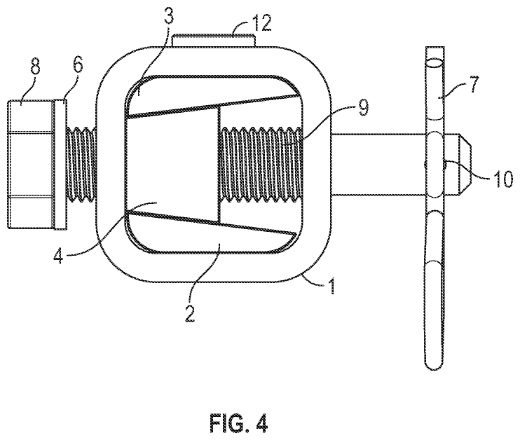

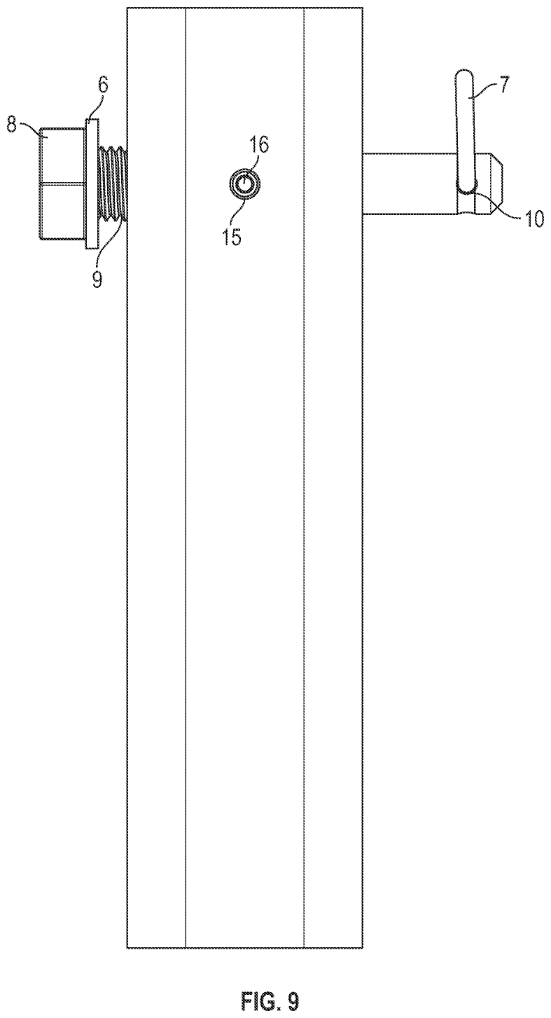

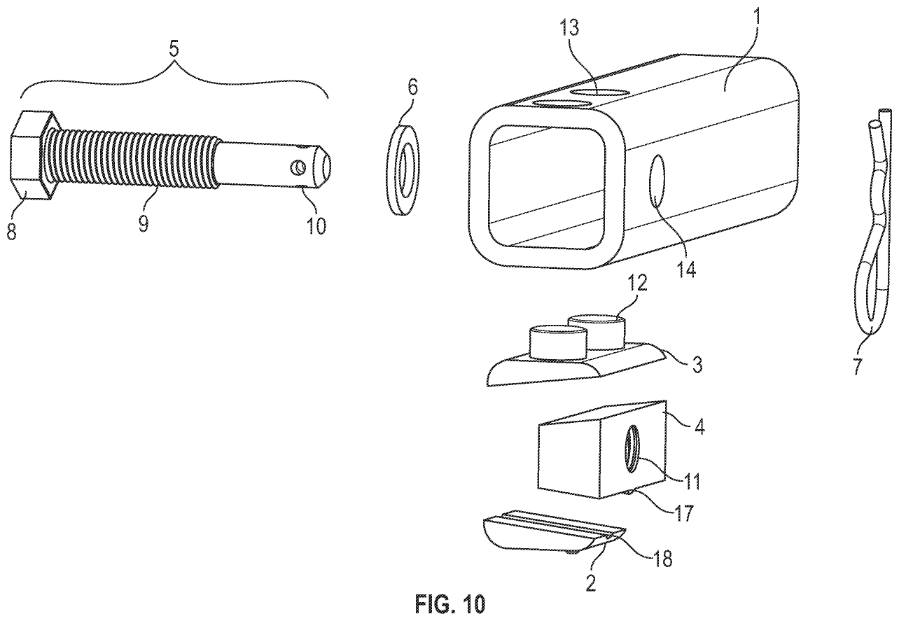

FIG. 4 is a front view. In this view, the pin head 8 is being rotated to pull the wedge 4 against the right side of the receiver tube 1. A pin threaded section 9 on the pin mates with a threaded wedge hole (11 in other figures) such that the wedge is “pulled” toward the pin head. As the wedge 4 is being pulled, it pushes the bottom plate 2 down, and the top plate 3 up. Prongs 12 on the top plate 3 push through receiver tube prong holes (13 in other figures) into the inner wall of a vehicle hitch receiver (illustrated more clearly in FIGS. 9 and 10. As the prongs 12 contact the inner wall of the vehicle hitch receiver, they force the bottom plate 2 against the inner wall of the bottom of the receiver tube 1. Once the wedge 4 is secured against the right side inner wall of the receiver tube 1, there are three solid points of contact: the wedge, the top plate and bottom plate pressing the receiver tube against the vehicle hitch receiver (not shown in this figure) and the washer 6, the prongs 12 against the inner surface of the upper portion of the vehicle hitch receiver, and the bottom plate 2 against the bottom of the receiver tube 1, which, in turn, presses against the inner surface of the bottom of the vehicle hitch receiver. The pin (referred to generally as 5 in other drawings), is secured by a cotter pin 7 that is slid through one of the pin holes 10.

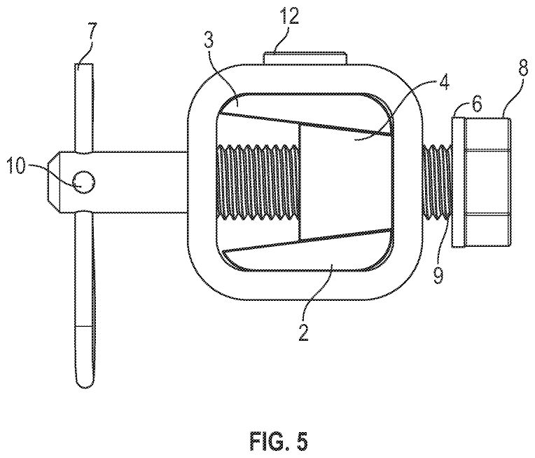

FIG. 5 is a back view. The parts of the invention are similar to FIG. 2, except that the back end of the receiver tube 1 is disclaimed as the length of the receiver tube is not a limiting factor on the thrust of the invention.

FIG. 6 is a right-side view, showing the end result of the prongs 12 being fully thrust through the receiver tube prong holes (13 in other figures).

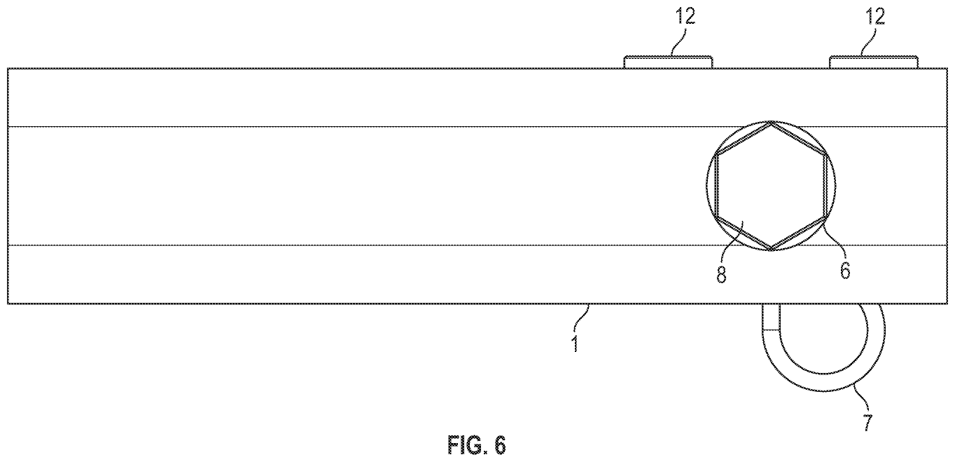

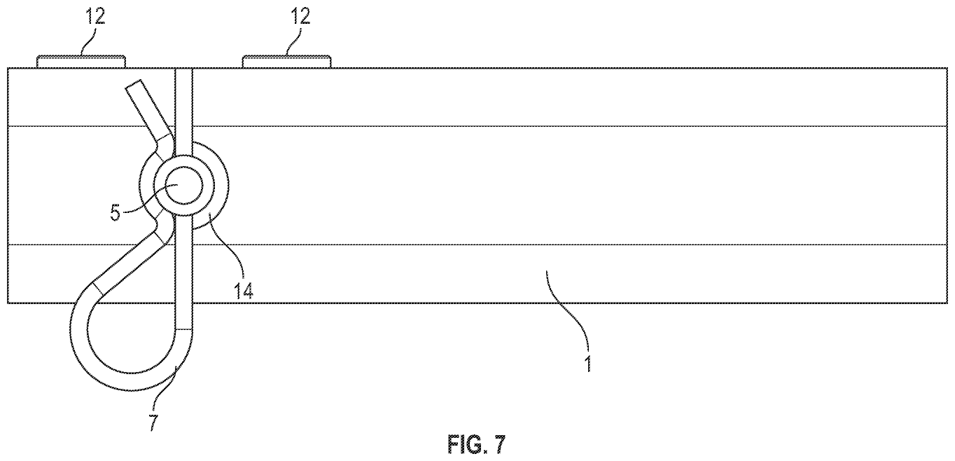

FIG. 7 is a left-side view. The pin 5 has been screwed through the mating wedge threads and now extends through the receiver tube hitch pin hole 14. A cotter pin 7 has been inserted through the pin hole to prevent the pin from backing out.

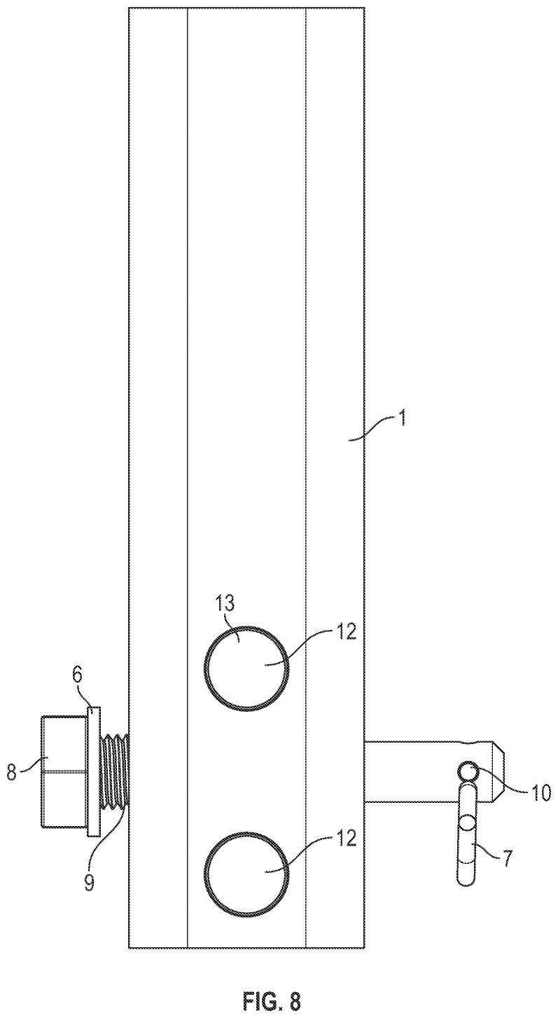

FIG. 8 is a top view. As the pin head 8 has been tightened, the pin threaded section 8 has engaged the mating threads in the wedge hole (11 in other figures) and have pulled the wedge toward the pin head 8. The washer 6 has contacted the vehicle hitch receiver (not shown in this figure, but better illustrated in FIGS. 9 and 10) and has forced the wedge such that the prongs 12 on the top plate (3 in other figures) have been forced through the receiver tube prong holes 13.

FIG. 9 is a bottom view. This figure shows how the bottom plate pilot 16 of the bottom plate (2 in other figures), nestles into a bottom plate securing hole 15 in the receiver tube 1. This pilot ensures that the invention does not wiggle out of alignment during tightening.

FIG. 10 is an exploded, perspective view showing the various parts of the invention prior to assembly. A receiver tube 1 can be slid into the hitch receiver of a vehicle. Attached to the receiver tube can be a trailer hitch, a bicycle or motorcycle rack, a cargo tray, a spare tire retainer or another other device that can be removably connected to a vehicle hitch receiver. One the sides of the receiver tube 1 are two receiver tube hitch pin holes 14, and on the top of the receiver tube are one or more receiver tube prong holes 13. It is contemplated that the number of receiver tube prong holes will be at least one, up to a large number of holes depending on the configuration of each embodiment.

A pin 5, has a washer 6, and slides through the two receiver tube hitch pin holes and is secured on the other side of the receiver tube by a cotter pin 7. The pin 5 has a pin head 8, a pin threaded section 9, and at the far end, away from the pin head 8, one or more pin holes 10.

Inside the receiver tube 1, a wedge 4 combines with a bottom plate 2 and a top plate 3 to provide the securing mechanism. The bottom plate 2 has a slot on its upper surface, which mates with a protrusion on the bottom of the wedge. The bottom plate and top plate are inserted first and held in place by one or more fingers, then the wedge is inserted as the prongs 12 on the top plate 3 are pushed though the receiver tube prong holes 13 on the receiver tube. This secures the entire unit inside the receiver tube so that the receiver tube can be inserted into a vehicle hitch receiver.

The wedge 4 has a threaded wedge hole 11. The bottom plate 2 is gently wedge-shaped, with a wider end and a slightly rounded lower surface which enhances its ability to be gradually pulled toward the pin head 8 as the pin threaded section 8 is screwed into the threaded wedge hole. The top plate 3 is also gently wedge-shaped, with a slightly rounded upper surface which enhances its ability to be gradually pulled toward the pin head 8 as the pin threaded section 8 is screwed into the threaded wedge hole. The top plate 3 also has one or more prongs 12 on its upper surface, which mate with the one or more receiver tube prong holes 13 on the receiver tube 1.

This embodiment of the invention functions as follows. In this embodiment, there are two prongs, which mate with two receiver tube holes. The wedge, top plate and bottom plate are organized in a sandwich fashion, with the wedge in between the top plate and bottom plate. The small end of the wedge is aimed toward the receiver tube hitch pin hole where the pin will be inserted. The receiver tube is inserted into a hitch receiver, with the wedge hole lined up with the two receiver tube hitch pin holes and the two hitch pin holes in the vehicle receiver tube. The pin is then inserted through the first receiver tube hitch pin hole and the pin threaded section engages mating threads in the wedge hole. As the pin is rotated, the pin threaded section “pulls” the wedge toward the side of the hitch receiver upon which rests the pin head, with easy rotation made possible by the washer. As the wedge is pulled toward the side of the receiver tube, the larger end of the wedge gradually pushes the bottom plate down and the top plate up. As the top plate is pushed up, the prongs extend beyond the receiver tube prong holes and begin to engage with the bottom surface of the hitch receiver. This pushes the bottom plate harder and harder against a top surface of the bottom of the receiver tube. Eventually, the prongs will force the bottom of the receiver tube against the hitch receiver, creating two securing points: the prongs against the top of the vehicle hitch receiver and the bottom plate pushing the bottom of the receiver tube against the bottom of the vehicle hitch receiver. A third securing point is created as the pin threaded portion can no longer rotate, which causes the wedge and the pin head to secure the side of the receiver tube to the side of the hitch receiver and “pin” both between the small end of the wedge and the washer/pin head.

In this particular embodiment, the prongs are elliptical in shape, as are the receiver tube holes, but any shape can be used so long as the prong can extend through its corresponding receiver tube prong hole.

FIG. 11 is an exploded, perspective view of a second embodiment of the invention showing the various parts of the invention prior to assembly. This embodiment functions very similarly to that illustrated in FIG. 10, expect in this case there are three prongs 12, and slide through three receiver tube prong holes 13 on the receiver tube 1.

FIG. 12 is an exploded view of the bottom plate, top plate and wedge. The bottom plate has a slot 18, into which the protrusion 17 on the wedge is inserted, and which guides the movement of the wedge. The bottom of the bottom plate 2 and the top of the top plate 3 are rounded on both lower corners to allow for a smoother travel across the top and bottom of the receiver tube. A bottom plate pilot 16 extends below the lower surface of the bottom plate 2.

FIG. 13 is a front view, showing the invention before the wedge 4 has been moved toward the pin head 8. A protrusion 17 on the bottom of the wedge will engage as slot (18 in other figures) on the top of the bottom plate 2. The pin, generally 5, has been inserted through hitch pin holes in the vehicle hitch receiver 17 and the receiver tube 1. The pin threaded section 9 has engaged mating holes in the wedge hole (11 in other figures) of the wedge 4. The prongs 12 of the top plate 3 and the bottom plate pilot 16 on the bottom plate 2 have not yet been activated.

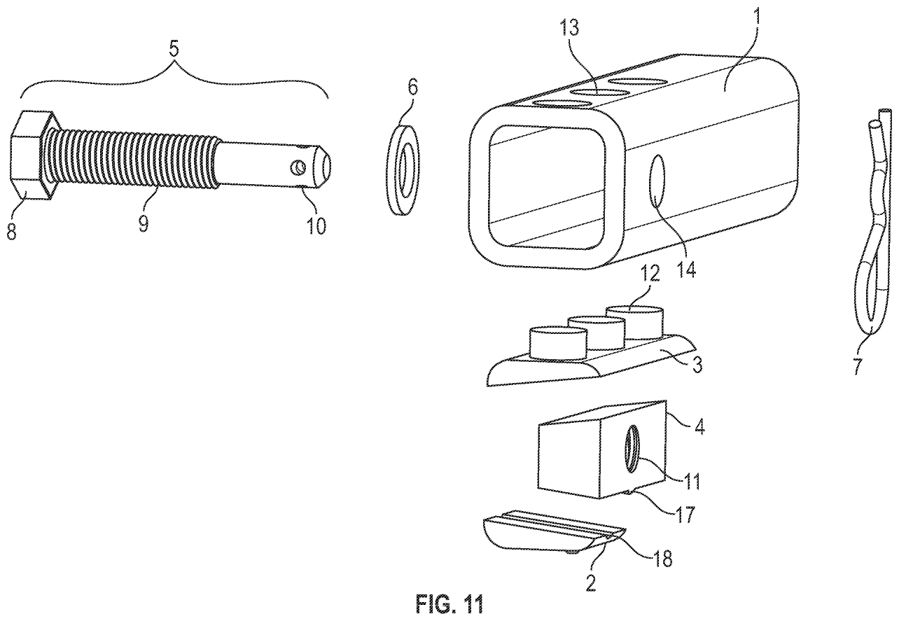

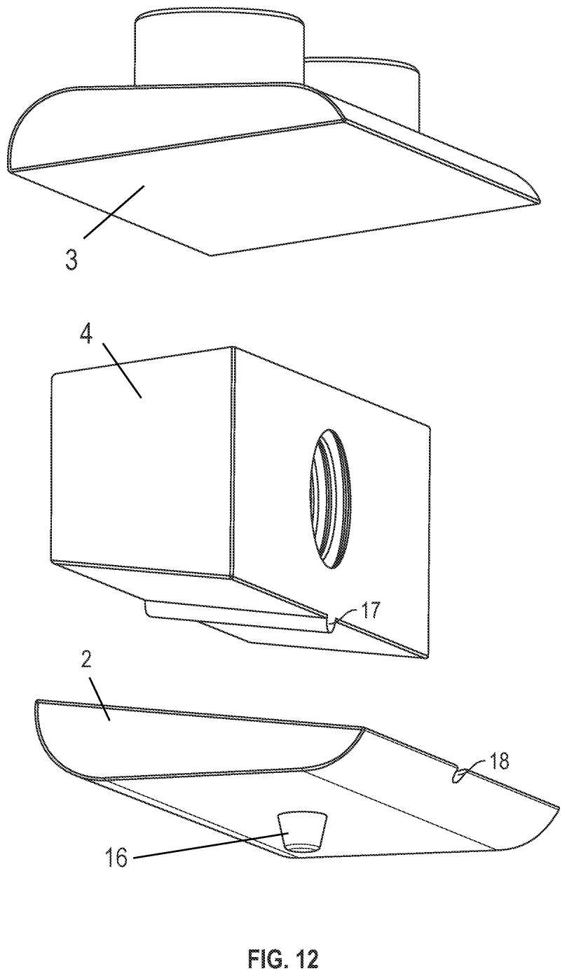

FIG. 14 is a front view, showing the invention after the wedge 4 has been screwed toward the pin head 8, forcing the top plate 3 in an upwards direction, and the bottom plate 2 in a downward direction. As the wedge 4 has been forced back against the receiver tube 1, the larger end of the wedge has gradually forced the prongs 12 in the top plate 3 to slide through receiver tube prong holes (13 in other figures) to press against the inner surface of the top of the vehicle hitch receiver 17. This, in turn, has forced the bottom plate 2 in a downward direction, forcing the bottom plate pilot 16 into the bottom plate securing hole (15 in other figures). This has effectively locked the receiver tube 1 on three sides, and prevented the anti-rattle problems found in the prior art. The washer 6 and pin head 8 have secured the right side of the vehicle hitch receiver 17 and the right side of the receiver tube 1 against the narrow end of the wedge 4. The prongs 12 have pushed the bottom plate and bottom of the receiver tube against the inner surface of the bottom of the receiver tube 1, thereby securing both the top and bottom of the receiver tube.

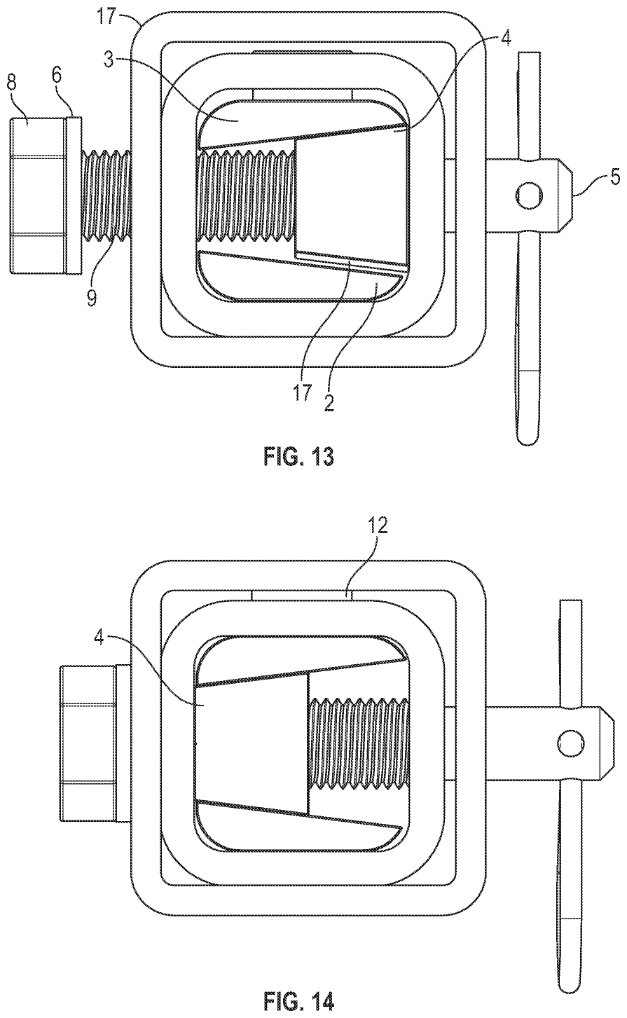

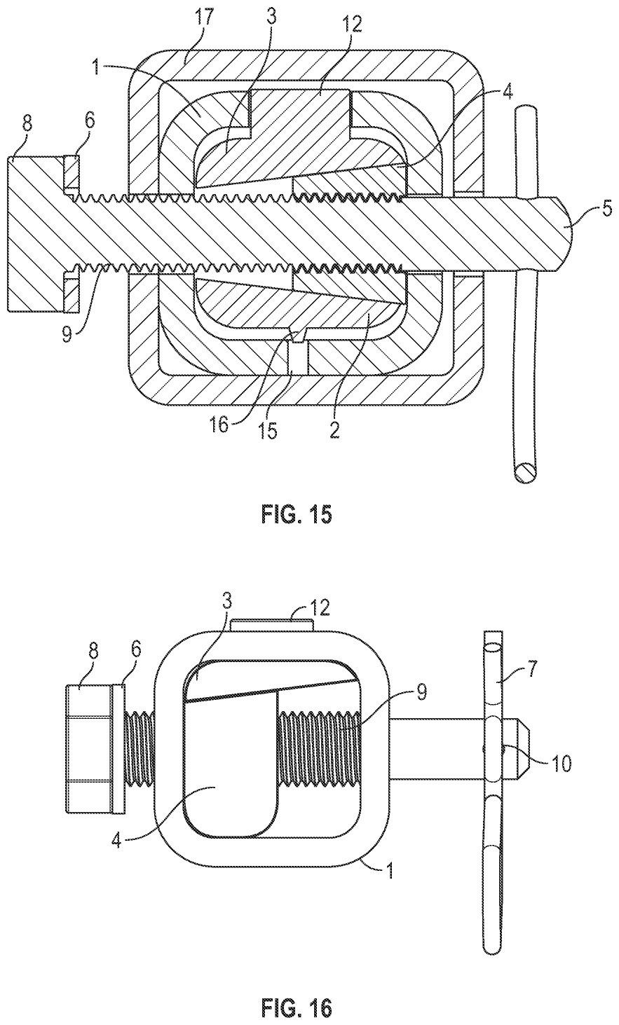

FIG. 15 is a cross sectional view showing how the various parts of the invention work together to secure a receiver tube in a vehicle hitch receiver. As the pin 5 is rotated, the wedge 4 is pulled toward the pin head 8. This forces the prongs 12 of the top plate 3 into the vehicle hitch receiver 17, which, in turn, forces to bottom of the receiver tube 1 against the inner surface of the bottom of the vehicle hitch receiver 17.

FIG. 16 is a front view of a second embodiment of the invention where the bottom plate has been removed and the wedge 4 has a different shape that is found in the first embodiment. Here, the top plate is inserted first and held in place while the wedge is inserted under the top plate. There is, optionally, a protrusion on the top face of the wedge which mates with a slot in the bottom of the top plate. In this embodiment, the wedge 4 has a flat bottom, with slightly rounded edges to allow for smooth travel across the bottom of the receiver tube 1. As the wedge 4 is pulled toward the pin head 8, the upper surface of the wedge pushes up on the top plate 3, forcing the prongs 12 into the inner wall of the top of the vehicle hitch receiver. The bottom of the wedge 4 is rounded on both lower corners to allow for a smoother travel across the bottom of the receiver tube.

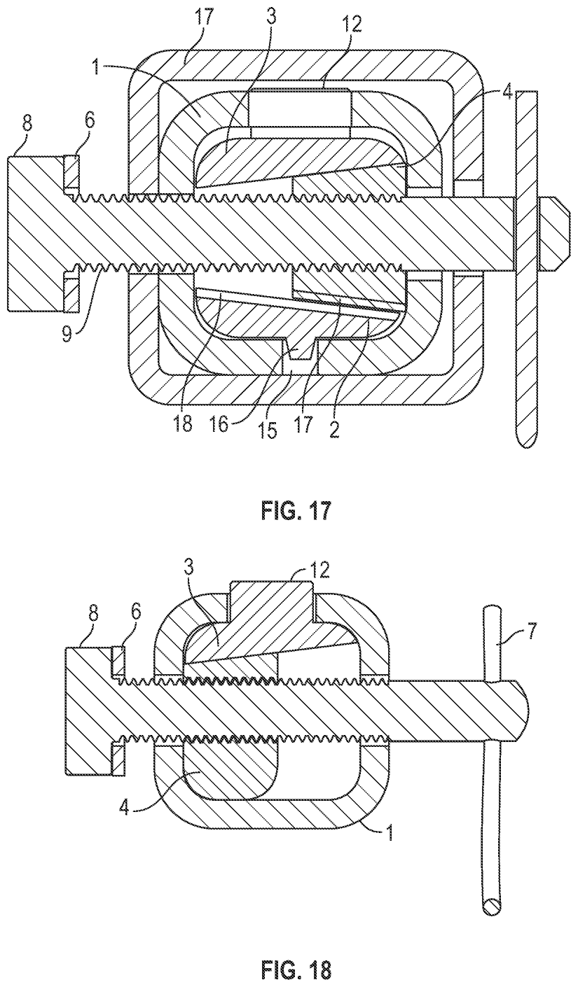

FIG. 17 is a cross-sectional view of the embodiment illustrated in FIG. 15. A pin, generally 9, extends through holes in a receiver tube 1 and a vehicle hitch receiver 17. A pin threaded section engages threads in a wedge 4. Above the wedge is a top plate 3 with prongs 12. The prongs line up through similarly sized and shaped holes in the receiver tube 1. Below the wedge is a bottom plate 2. A protrusion 17 on the bottom of the wedge slides through a slot 18 on the top of the bottom plate. On the bottom of the bottom plate, a pilot 16 engages a similarly sized and shaped hole 15 in the receiver tube. As the pin is rotated, the wedge 4 is pulled in the direction of the pin head 8. A washer 6 allows for smooth rotation. The wedge slides easily toward the pin head as the protrusion 17 keeps the wedge aligned by moving through the slot 18. As the wedge is rotated toward the washer, the larger end of the wedge gradually pushes the prongs 12 into the top of the vehicle hitch receiver 17, and the bottom plate 2 against the bottom of the receiver 1, which pushes the receiver tube against the vehicle hitch receiver 17. Once the pin cannot be rotated further, the edges of the top plate and bottom plate sandwich the receiver tube and the vehicle hitch receiver against the washer 6.

FIG. 18 is a cross-sectional view of the embodiment illustrated in FIG. 16. The wedge 4 in this embodiment has a flat bottom that slides across the inner surface of the bottom of the receiver tube 1. Rounded edges ensure that this movement is smooth, without the chance of catching that would accompany a wedge with sharp edges. The upper surface of the wedge is inclined, so that as the wedge is screwed toward the pin head 8, this upper surface gradually forces the prongs 12 up, where they contact the inner surface of the top of the vehicle receiver. This embodiment optionally has a protrusion on the top surface of the wedge, and a mating slot on the bottom of the top plate.

The proposed anti-rattle device when compared with other known devices and solutions provides technical advancements including, but not limited to, (i) securement of a receiver tube in a vehicle hitch receiver on three sides, (ii) internal components that remove the danger of water, dirt and grime impeding the movement of key components.

The disclosed anti-rattle device is unique in that it is structurally different from other known devices or solutions. More specifically, the key components of the device are located within the receiver tube, and thereby protected from the elements. Furthermore, by creating pressure on three sides of the receive tube, this invention provides a superior means of preventing rattling between a receiver tube and a vehicle hitch receiver.

In one embodiment, the invention is an anti-rattle device for securing a receiver tube in a vehicle hitch receiver, which includes a receiver tube, wherein the receiver tube has a hollow interior, a top side, a bottom side, a right side and a left side, wherein the receiver tube additionally comprises a first receiver tube hitch pin hole on the right side and a second receiver tube hitch pin hole on the left side, wherein the receiver tube additionally comprises at least one receiver turn prong hole on the top side, a bottom plate, wherein the bottom plate has a bottom plate upper side, and the bottom plate upper side has a slot, a top plate with one or more prongs on a top plate upper surface, wherein the one or more prongs have a prong shape that mates with a receiver tube prong hole shape, such that the one or more prongs can enter and exit from the one or more receiver tube prong holes, a wedge with a threaded wedge hole, wherein the wedge additionally comprises a protrusion on a wedge lower face, a pin with a pin head and a pin threaded section, wherein, the top plate and the bottom plate are inserted into the hollow interior of the receiver tube, and held in place by one or more fingers of a user, wherein, the bottom plate is mated to the wedge through insertion of the protrusion into the slot, wherein the pin is inserted through the first receiver tube hitch pin hole and the pin threaded section is threaded into the threaded wedge hole, wherein the pin head is rotated, gradually pulling the wedge toward the pin head, wherein, as the wedge moves towards the pin head, the bottom plate is pushed in a downward direction and the top plate is pushed in an upward direction, wherein the movement of the wedge is confined to a linear path by the protrusion and the slot, wherein the one or more prongs eventually contacts a vehicle receiver hitch upper inner wall of a vehicle receiver hitch, wherein this action forces the bottom plate against a receiver tube inner surface on the bottom side of the receiver tube, wherein, once the one or more prongs and the bottom plate are secured, the rotation of the pin head is stopped.

This embodiment also envisions that the receiver tube additionally comprises a bottom plate securing hole on the bottom side of the receiver tube, and wherein the bottom plate additionally comprises a bottom plate pilot on a bottom plate bottom side, and wherein the bottom plate pilot nestles in the bottom plate securing hole, thereby preventing the bottom plate from sliding within the receiver tube, wherein the pin additionally comprises a pin hole at a far end of the pin, opposite the pin head, wherein once the pin has been rotated to secure the receiver tube in the vehicle hitch receiver, a cotter pin can be inserted into the pin hole to prevent the pin from backing out of the threaded wedge hole, where the top plate upper surface has rounded corners to allow for the top plate to slide across the top side of the receiver tube, and where a bottom plate bottom surface has rounded corners to allow for the bottom plate to slide across the bottom side of the receiver tube, and, additionally comprising a washer, wherein the washer is located between the pin head and the pin threaded section, wherein the washer allows for a smooth rotation of the pin.

Furthermore, those skilled in the art can appreciate that the above description does not provide specific details of the manufacture or design of the various components. Those of skill in the art are familiar with such details, and unless departures from those techniques are set out, techniques, known, related art or later developed designs and materials should be employed. Those in the art can choose suitable manufacturing and design details.

Further, the terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. An anti-rattle device for securing a receiver tube in a vehicle hitch receiver, consisting of:
a receiver tube, wherein the receiver tube has a hollow interior, a top side, a bottom side, a right side and a left side, wherein the receiver tube additionally comprises a first receiver tube hitch pin hole on the right side and a second receiver tube hitch pin hole on the left side, wherein the receiver tube additionally comprises at least one receiver turn prong hole on the top side,
a bottom plate, wherein the bottom plate has a bottom plate upper side, and the bottom plate upper side has a slot,
a top plate with one or more prongs on a top plate upper surface, wherein the one or more prongs have a prong shape that mates with a receiver tube prong hole shape, such that the one or more prongs can enter and exit from the one or more receiver tube prong holes,
a wedge with a threaded wedge hole, wherein the wedge additionally comprises a protrusion on a wedge lower face,
a pin with a pin head and a pin threaded section,
wherein, the top plate and the bottom plate are inserted into the hollow interior of the receiver tube, and held in place by one or more fingers of a user,
wherein, the bottom plate is mated to the wedge through insertion of the protrusion into the slot,
wherein the pin is inserted through the first receiver tube hitch pin hole and the pin threaded section is threaded into the threaded wedge hole, wherein the pin head is rotated, gradually pulling the wedge toward the pin head,
wherein, as the wedge moves towards the pin head, the bottom plate is pushed in a downward direction and the top plate is pushed in an upward direction, wherein the movement of the wedge is confined to a linear path by the protrusion and the slot,
wherein the one or more prongs eventually contacts a vehicle receiver hitch upper inner wall of a vehicle receiver hitch,
wherein this action forces the bottom plate against a receiver tube inner surface on the bottom side of the receiver tube,
wherein, once the one or more prongs and the bottom plate are secured, the rotation of the pin head is stopped.

2. The device of claim 1, wherein the receiver tube additionally comprises a bottom plate securing hole on the bottom side of the receiver tube, and wherein the bottom plate additionally comprises a bottom plate pilot on a bottom plate bottom side, and wherein the bottom plate pilot nestles in the bottom plate securing hole, thereby preventing the bottom plate from sliding within the receiver tube.

3. The device of claim 2, wherein the pin additionally comprises a pin hole at a far end of the pin, opposite the pin head, wherein once the pin has been rotated to secure the receiver tube in the vehicle hitch receiver, a cotter pin can be inserted into the pin hole to prevent the pin from backing out of the threaded wedge hole.

4. The device of claim 3, where the top plate upper surface has rounded corners to allow for the top plate to slide across the top side of the receiver tube, and where a bottom plate bottom surface has rounded corners to allow for the bottom plate to slide across the bottom side of the receiver tube.

5. The device of claim 4, additionally comprising a washer, wherein the washer is located between the pin head and the pin threaded section, wherein the washer allows for a smooth rotation of the pin.

6. An anti-rattle device for securing a receiver tube in a vehicle hitch receiver, comprising:
a receiver tube, wherein the receiver tube has a hollow interior, a top side, a bottom side, a right side and a left side, wherein the receiver tube additionally comprises a first receiver tube hitch pin hole on the right side and a second receiver tube hitch pin hole on the left side, wherein the receiver tube additionally comprises at least one receiver tube prong hole on the top side,
a top plate with one or more prongs, wherein the one or more prongs have a prong shape that mates with a receiver tube prong hole shape, such that the one or more prongs can enter and exit from the one or more receiver tube prong holes, a wedge with a threaded wedge hole,
a pin with a pin head and a pin threaded section,
wherein, the top plate and the bottom plate are inserted into the hollow interior of the receiver tube, and held in place by one or more fingers of a user,
wherein, the bottom plate is mated to the wedge through insertion of the protrusion into the slot,
wherein the pin is inserted through the first receiver tube hitch pin hole and the pin threaded section is threaded into the threaded wedge hole,
wherein the pin head is rotated, gradually pulling the wedge toward the pin head,
wherein, as the wedge moves towards the pin head, and the top plate is pushed in an upward direction, wherein the movement of the wedge is confined to a linear path by the protrusion and the slot,
wherein the one or more prongs eventually contacts a vehicle receiver hitch upper inner wall of a vehicle receive hitch,
wherein, once the one or more prongs, the rotation of the pin head is stopped.

7. The device of claim 6, where the wedge has a flat wedge bottom, a wedge narrow side, where the wedge narrow side is perpendicular to the wedge bottom, a wedge large side, where the wedge large side is perpendicular to the wedge bottom, and a slanted wedge top side.

8. The device of claim 7, wherein the flat wedge bottom has two rounded corners to allow for the flat wedge bottom to slide across the bottom side of the receiver tube.

9. The device of claim 8, wherein the pin additionally comprises a pin hole at a far end of the pin, opposite the pin head, wherein once the pin has been rotated to secure the receiver tube in the vehicle hitch receiver, a cotter pin can be inserted into the pin hole to prevent the pin from backing out of the threaded wedge hole.

10. The device of claim 9, additionally comprising a washer, wherein the washer is located between the pin head and the pin threaded section, wherein the washer allows for a smooth rotation of the pin.

11. The device of claim 6, additionally comprising a bottom plate,
wherein, the bottom plate is mated to the wedge through insertion of a wedge protrusion into a slot on the bottom plate, and then is inserted into the hollow interior of the receiver tube, after which the top plate is inserted into the hollow interior of the receiver tube, above the wedge,
wherein a wedge narrow end faces the first receiver tube hitch pin hole, and a wedge large end faces the second receiver tube hitch pin hole,
wherein as the pin is rotated and the wedge pulled toward the first receiver tube hitch pin hole the bottom plate is pushed in a downward direction and, wherein this action forces the bottom plate against a receiver tube inner surface on the bottom side of the receiver tube, and the bottom plate are secured.

12. The device of claim 11, wherein the receiver tube additionally comprises a bottom plate securing hole on the bottom side of the receiver tube, and wherein the bottom plate additionally comprises a bottom plate pilot on a bottom plate bottom side, and wherein the bottom plate pilot nestles in the bottom plate securing hole, thereby preventing the bottom plate from sliding within the receiver tube.

13. The device of claim 12, wherein the pin additionally comprises a pin hole at a far end of the pin, opposite the pin head, wherein once the pin has been rotated to secure the receiver tube in the vehicle hitch receiver, a cotter pin can be inserted into the pin hole to prevent the pin from backing out of the threaded wedge hole.

14. The device of claim 13, additionally comprising a washer, wherein the washer is located between the pin head and the pin threaded section, wherein the washer allows for a smooth rotation of the pin.

15. A method of securing a receiver tube in a vehicle hitch receiver, comprising the steps of: first, obtaining an anti-rattle device for securing a receiver tube in a vehicle hitch receiver, where the anti-rattle device comprises:
a receiver tube, wherein the receiver tube has a hollow interior, a top side, a bottom side, a right side and a left side, wherein the receiver tube additionally comprises a first receiver tube hitch pin hole on the right side and a second receiver tube hitch pin hole on the left side, wherein the receiver tube additionally comprises at least one receiver turn prong hole on the top side,
a bottom plate,
a top plate with one or more prongs on a top plate upper surface, wherein the one or more prongs have a prong shape that mates with a receiver tube prong hole shape, such that the one or more prongs can enter and exit from the one or more receiver tube prong holes,
a wedge with a threaded wedge hole, wherein the wedge additionally comprises a protrusion on a wedge lower face,
a pin with a pin head and a pin threaded section,
wherein, the top plate and the bottom plate are inserted into the hollow interior of the receiver tube, and held in place by one or more fingers of a user,
wherein, the bottom plate is mated to the wedge through insertion of the protrusion into the slot,
second, line up two receiver tube hitch pin holes with two vehicle receiver hitch pin holes on a vehicle receiver,
third, inserting the pin through the first receiver tube hitch pin hole threading the pin threaded section through the threaded wedge hole,
fourth, rotating the pin head, gradually pulling the wedge toward the pin head, such that as the wedge moves towards the pin head, the bottom plate is pushed in a downward direction and the top plate is pushed in an upward direction, wherein the movement of the wedge is confined to a linear path by a protrusion on a wedge bottom surface of the wedge and a slot on a bottom plate upper surface of the bottom plate.

16. The method of claim 15, comprising a fifth step of continuing to rotate the pin head until the one or more prongs eventually contacts a vehicle receiver hitch upper inner wall of a vehicle receive hitch, wherein this action forces the bottom plate against a receiver tube inner surface on the bottom side of the receiver tube.

17. The method of claim 16, comprising a sixth step of once the one or more prongs and the bottom plate are secured, ceasing the rotation of the pin head.

18. The method of claim 17, wherein the receiver tube additionally comprises a bottom plate securing hole on the bottom side of the receiver tube, and wherein the bottom plate additionally comprises a bottom plate pilot on a bottom plate bottom side, and wherein the bottom plate pilot nestles in the bottom plate securing hole, thereby preventing the bottom plate from sliding within the receiver tube.

19. The method of claim 18, wherein the pin additionally comprises a pin hole at a far end of the pin, opposite the pin head, wherein once the pin has been rotated to secure the receiver tube in the vehicle hitch receiver, a cotter pin can be inserted into the pin hole to prevent the pin from backing out of the threaded wedge hole.

20. The method of claim 19, where the top plate upper surface has rounded corners to allow for the top plate to slide across the top side of the receiver tube, and where a bottom plate bottom surface has rounded corners to allow for the bottom plate to slide across the bottom side of the receiver tube, wherein the device additionally comprises a washer, wherein the washer is located between the pin head and the pin threaded section, wherein the washer allows for a smooth rotation of the pin.

21. An anti-rattle device for securing a receiver tube in a vehicle hitch receiver, comprising:
a receiver tube, wherein the receiver tube has a hollow interior, a top side, a bottom side, a right side and a left side, wherein the receiver tube additionally comprises a first receiver tube hitch pin hole on the right side and a second receiver tube hitch pin hole on the left side, wherein the receiver tube additionally comprises at least one receiver turn prong hole on the top side,
a bottom plate,
a top plate with one or more prongs on a top plate upper surface, wherein the one or more prongs have a prong shape that mates with a receiver tube prong hole shape, such that the one or more prongs can enter and exit from the one or more receiver tube prong holes,
a wedge with a threaded wedge hole,
a pin with a pin head and a pin threaded section,
wherein the pin is inserted through the first receiver tube hitch pin hole and the pin threaded section is threaded into the threaded wedge hole,
wherein the pin head is rotated, gradually pulling the wedge toward the pin head,
wherein, as the wedge moves towards the pin head, the bottom plate is pushed in a downward direction and the top plate is pushed in an upward direction, wherein the movement of the wedge is confined to a linear path by the protrusion and the slot,
wherein the one or more prongs eventually contacts a vehicle receiver hitch upper inner wall of a vehicle receiver hitch,
wherein this action forces the bottom plate against a receiver tube inner surface on the bottom side of the receiver tube,
wherein, once the one or more prongs and the bottom plate are secured, the rotation of the pin head is stopped.

22. The device of claim 21, wherein the bottom plate has a bottom plate upper side, and the bottom plate upper side has a slot, wherein the wedge additionally comprises a protrusion on a wedge lower face, wherein, the bottom plate is mated to the wedge through insertion of the protrusion into the slot.

23. The device of claim 22, wherein the receiver tube additionally comprises a bottom plate securing hole on the bottom side of the receiver tube, and wherein the bottom plate additionally comprises a bottom plate pilot on a bottom plate bottom side, and wherein the bottom plate pilot nestles in the bottom plate securing hole, thereby preventing the bottom plate from sliding within the receiver tube.

24. The device of claim 23, wherein the pin additionally comprises a pin hole at a far end of the pin, opposite the pin head, wherein once the pin has been rotated to secure the receiver tube in the vehicle hitch receiver, a cotter pin can be inserted into the pin hole to prevent the pin from backing out of the threaded wedge hole.

25. The device of claim 24, where the top plate upper surface has rounded corners to allow for the top plate to slide across the top side of the receiver tube, and where a bottom plate bottom surface has rounded comers to allow for the bottom plate to slide across the bottom side of the receiver tube.

26. The device of claim 25, additionally comprising a washer, wherein the washer is located between the pin head and the pin threaded section, wherein the washer allows for a smooth rotation of the pin.
